(19) United States
(12) Patent Application Publication
(10) Pub. No.: US 2007/0235604 A1
(43) Pub. Date: Oct. 11, 2007

(54) Tripod for Supporting a Video/Photographic Equipment

(76) Inventor: Paolo Speggiorin, Mussolente (VI) (IT)

Correspondence Address: RATNERPRESTIA, P O BOX 980, VALLEY FORGE, PA, 19482-0980, US

(21) Appl. No.: 11/630,464

(22) PCT Filed: Jul. 25, 2005
(86) PCT No.: PCT/EP05/08066

§ 371 Date: Dec. 21, 2006

(30) Foreign Application Priority Data
Jul. 23, 2004 (IT) PD2004A000198

(51) Int. Cl. F16M 11/32

(52) U.S. Cl. 248/177.1

(57) ABSTRACT

A tripod for electronic apparatus, in particular of the video/photographic type, including support elements, on which photovoltaic cells and relevant connection devices are arranged, for converting solar energy into electrical energy so as to supply electrical energy to the apparatus supported.

This application is a U.S. National Phase Application of PCT International Application PCT/EP2005/008066 which is incorporated by reference herein.

The present invention relates to a tripod for supporting video/photographic equipment, of the type including photovoltaic means for supplying electrical energy to the equipment.

### TECHNICAL FIELD

In recent years, video cameras and photographic (still) cameras of the digital type have become increasingly widespread. In these devices, conventional film is replaced by an electronic sensor and the still or moving images can be viewed on a display and can be stored on rewritable media of various types, such as non-volatile memory cards, magnetic tapes or optical compact discs.

These devices have many advantages over conventional photographic apparatuses and they are further very suitable for non-professional use owing to their simplicity of use and their generally very compact dimensions.

### BACKGROUND OF THE INVENTION

Along with the numerous advantages arising from the heavy use of electronic processing systems, however, these apparatuses have a much higher consumption of electrical energy than conventional apparatuses. Furthermore, in order to reduce weights and dimensions more and more, the internal batteries are small and have small capacities, with the result that only a limited lifetime is ensured in terms of the number of exposures and operating time.

At present, in order to obtain a satisfactory lifetime, it is therefore necessary to provide spare batteries and, should a source of electrical energy be available, a suitable battery charger.

However, the spare batteries, the cables and the various accessories needed for their recharging constitute an increase in weight and volume over conventional photographic equipment, which normally also already includes a tripod support or support of another type. It should further be added that in some locations a source of electrical energy is not available for recharging the batteries.

Supports of the fixed pole type provided with solar cells and means to store electrical energy are disclosed in EP 0849524 and in JP 2004207109.

### BRIEF DESCRIPTION OF THE INVENTION

The main object of the present invention is to construct a support for cameras which is structurally and functionally configured in such a manner as to overcome all the disadvantages mentioned with reference to the prior art cited.

Another object of the invention is to construct a support which allows the lifetime of a camera to be increased without adding excessive weight and size with respect to conventional equipment.

Another object of the invention is to allow the batteries of the camera also to be recharged in locations where no electrical network is available.

These objects and others, which will be better appreciated from the description below, are achieved by the tripod of the present invention.

The present invention is directed to a tripod for supporting video/photographic equipment. The tripod includes support elements comprising at least three legs, which are pivotally attached at one end to the crosspiece. In addition, photovoltaic means for converting solar energy into electrical energy are arranged on at least one of the legs, and means are provided for releasably connecting the photovoltaic means to the video/photographic equipment to supply electrical energy to the video/photographic equipment.

### BRIEF DESCRIPTION OF THE DRAWINGS

The features and advantages of the invention will be better appreciated from the detailed description of a preferred embodiment thereof which is illustrated, purely by way of non-limiting example, with reference to the appended drawings, in which:

FIG. 1 is a perspective view of a support for cameras comprising photovoltaic panels according to the invention;

FIG. 2 is a partially enlarged perspective view of a flexible photovoltaic element of the support of FIG. 1;

FIG. 3 is a partial perspective view of the cross-piece of the support of FIG. 1;

FIG. 4 is a cross-section of one of the upper tubular elements of the support of FIG. 1 in accordance with a second embodiment of the present invention;

FIG. 5 is a cross-section of one of the upper tubular elements of the support of FIG. 1 in accordance with a third embodiment of the present invention;

FIG. 6 is a schematic perspective view of an alternative embodiment of the invention in an operative position;

FIG. 7 is a schematic perspective view of the embodiment of FIG. 7 in an rest position;

FIG. 8 is a cross section view of a detail of FIG. 6 in an enlarged scale.

### PREFERRED EMBODIMENTS OF THE INVENTION

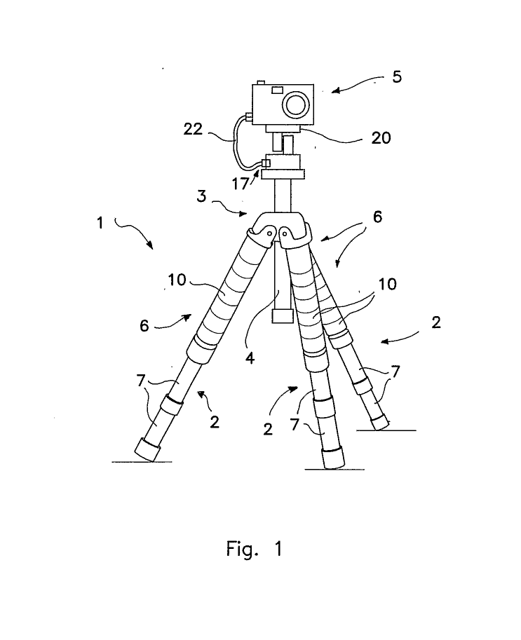

With reference to the embodiment illustrated in FIG. 1, a support of the tripod type for cameras, which is generally designated 1, comprises support elements including three legs designated 2, a cross-piece 3, in which the three legs 2 converge and are articulated by means of one end thereof, a column 4 which is arranged so as to be slidable in a controllable manner in an axial hole of the cross-piece 3 and a flange 20 which is arranged at the top of the column 4 for securing a camera 5.

Each leg comprises an upper tubular element, designated 6, in which a plurality of tubular elements 7 are inserted and can be telescopically withdrawn from each other.

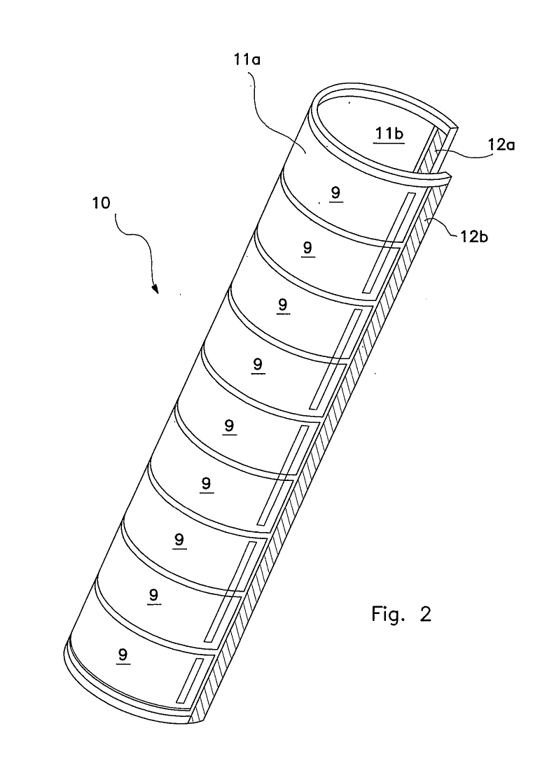

As shown in FIG. 2, each upper tubular element 6 is covered by a flexible panel-like element 10 having opposed major surfaces 11a, b and opposed edges 12a, b, which, when in use, are arranged parallel with the axis of the leg 2.

The panel-like element 10 is fitted on the tubular element 6, encircling it. With this arrangement, the edges 12a, b are brought near each other or partially overlap.

Along the edges, there are stitched, or otherwise applied, respective fastening means and counter-means for example, constituted by the two strips of a sliding clasp fastener, better known under the trade name “zip fastener”, or of the stick strap fasteners type, better known under the registered mark VELCRO™. It is alternatively possible to provide, on each edge, a plurality of eyelets for, for example, a lace type fastening or equivalent fastening means which are well known per se to the person skilled in the art.

The surface 11b is rendered adhesive by application of a layer of adhesive in order to ensure firm fixing to the element 6.

The surface 11a comprises flexible or rigid photovoltaic elements which are subdivided into a plurality of photovoltaic cells 9. The flexibility required is that necessary for adaptation to the curvature of the leg 2 in order to allow adaptation of the shape to the surface of the element 6. Owing to their mechanical strength and their conversion efficiency, flexible panels having silicon microspheres which are known under the mark Spheral Solar™, or other similar products, are particularly suitable for this type of application.

The use of microsphere type panels is particularly useful in this application owing to lesser sensitivity of the panels to the angle of incidence of the rays of the sun in comparison with conventional planar silicon photovoltaic cells. This allows satisfactory levels of electrical energy to be obtained by making use of structural elements of the tripod without the need to provide flat and orientatable surfaces.

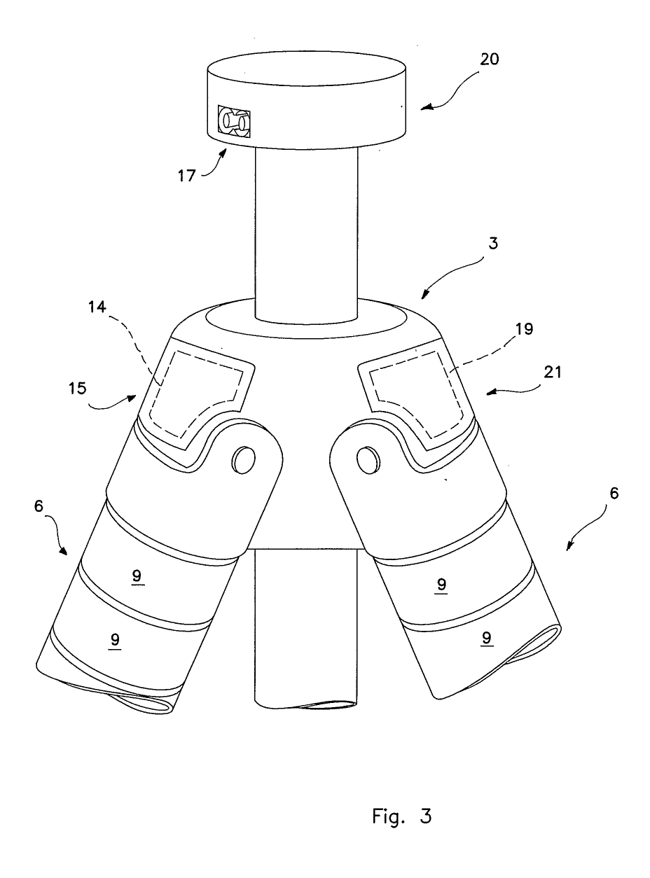

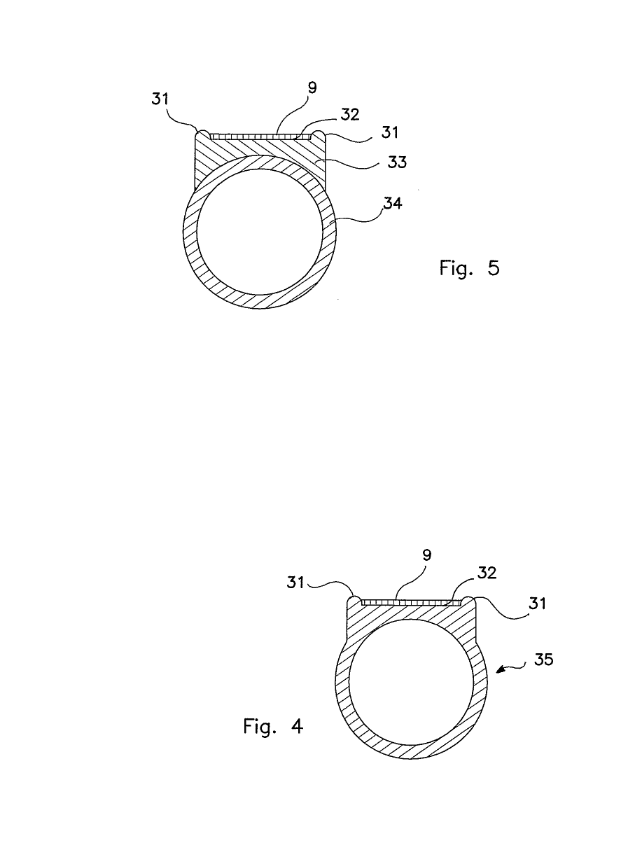

In a second embodiment, illustrated in FIG. 4, the tubular element 6 is formed by a semi-processed extrusion 35 which externally has a flat surface 32 which is located between two shoulders 31 and which extends over the entire length thereof. In a third embodiment, illustrated in FIG. 5, the tubular element 6 is obtained by assembling a support 33 on a cylindrical rod 34. In this case, the support 33 can be fitted on the cylindrical rod by means of adhesive bonding or other suitable fixing method when it is not extruded together with the tubular cylindrical element which constitutes the upper portion of the leg of the tripod.

The flat surface 32 obtained in this manner is covered with photovoltaic panels which comprise a plurality of photovoltaic cells 9. Panels which are rigid or flexible to a limited extent can be used in this case.

The photovoltaic cells 9 are electrically connected to an input port of an electronic circuit 14 which is accommodated in a recess 15 which is formed inside the cross-piece 3. The electronic circuit 14 has an output port connected to an output connector 17.

The electronic circuit 14 is optionally also connected to one or more rechargeable batteries 19 which are accommodated in a recess 21 which is suitably formed or produced inside the column 4.

The camera 5 is connected to the connector 17 by means of a suitable supply cable 22. Advantageously, the connector 17 can be positioned near the fixing flange 20.

When the photovoltaic cells 9 are exposed to solar radiation, the incident solar energy is converted into electrical energy and transferred to the circuit 14. The circuit 14 allows the photovoltaic cells 9 to be operated with maximum efficiency and, at the same time, controls the electrical power supplied to the camera and supplies the excess power to the batteries 19.

When the power required by the camera exceeds that provided by the photovoltaic cells, such as, for example, in the case of insufficient light or high momentary absorption of energy by the camera, the circuit 14 draws the shortfall of energy from the batteries 19.

The invention described allows the provision, in any location, of a source of electrical energy for the operation of the camera or for recharging the internal batteries thereof, without, despite that, affecting the normal dimensions of the equipment conventionally in use.

Furthermore, owing to the presence of its own internal batteries, this device is also able to provide the stored energy at times when it is not exposed to the sun. Again, owing to the internal batteries, the device is able to provide the high power which is necessary, for example, for rapid recharging of the batteries contained in the cameras.

The present invention is advantageously integrated in a photographic support, thereby allowing the user to have, with a completely negligible increase in the spatial dimensions of the equipment normally used, a supplementary source of energy for the camera.

Although the invention is described by way of example in relation to a photographic tripod, it will be appreciated that the same can be applied to supports of any type, such as single-leg supports or stands of any form.

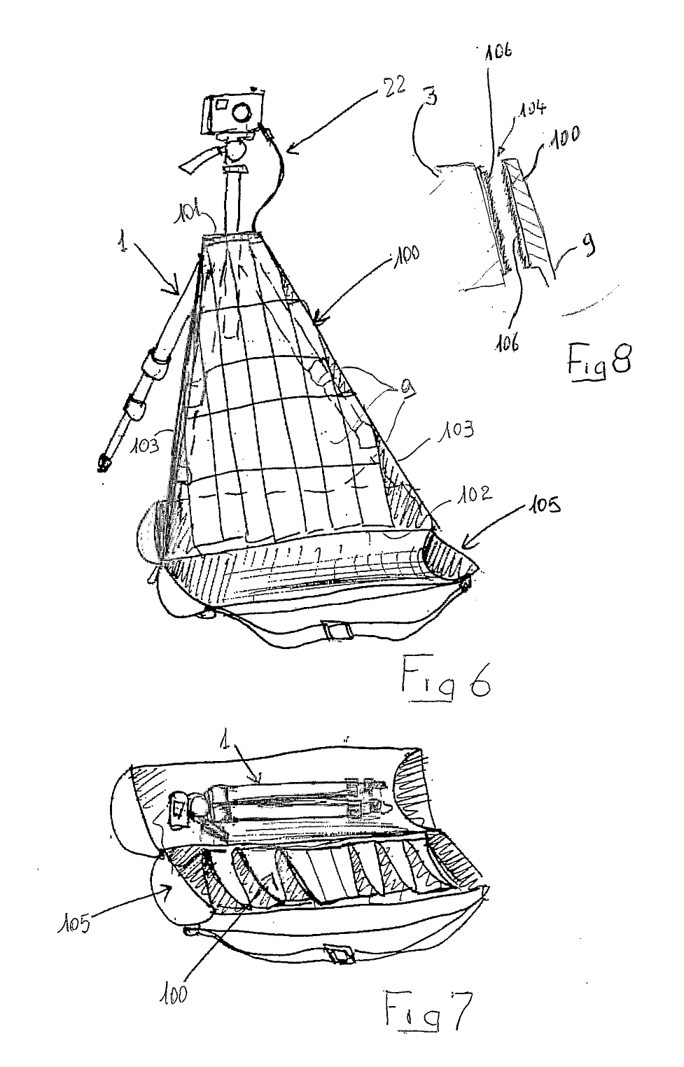

In an alternative embodiment of the invention (FIGS. 6 and 7), the photovoltaic cells 9 are integrated in a flexible panel 100 adapted to be laid between two adjacent legs of the tripod 1 as shown in FIG. 6. In this example the panel 100 preferably has a isosceles trapezoidal shape, with a minor basis 101, a major basis 102 an oblique sides 103. The minor basis 101 and the oblique sides 103 are provided with fixing means 104 for removably fixing to the cross-piece 3 or to the legs 2 or even to other parts of the tripod. The major base 102 is on its turn fixed or fixable to a container 105 adapted to contain at rest both the tripod 1 and the panel 100. The fixing means 104 as well as the means for fixing to each other the container 105 and the panel 100 can be obtained by way of example by means of fasteners 106 of the kind known under the trademark VELCRO. As an alternative it is envisaged that the panel can be fixed to the ground by means of spikes or similar means, or not fixed to the ground at all, being sufficiently fixing to the cross-piece 3 and the legs 2 to keep it extended.

Although the illustrative embodiments of the present invention has been described in detail with reference to the accompanying drawings, it is to be understood that the invention is not limited to these precise embodiments and that various changes or modifications may be effected therein by one skilled in the art without departing from the scope or spirit of the invention.

1. A tripod for supporting video/photographic equipment, the tripod including support elements comprising at least three legs, pivotally attached at one end to a crosspiece, and photovoltaic means for converting solar energy into electrical energy, arranged on at least one of said legs, and means for releasably connecting the photovoltaic means to the equipment in order to supply electrical energy to the equipment.

2. The tripod according to claim 1, comprising circuit means which are connected to the photovoltaic means and the connection means.

3. The tripod according to claim 1, wherein each of said legs comprises a tubular upper element and wherein the photovoltaic means for converting energy extend over the outer surface of said tubular upper element.

4. The tripod according to claim 3, wherein the energy conversion means comprise flexible photovoltaic panels.

5. The tripod according to claim 4, wherein the flexible photovoltaic panels are of the silicon microsphere type.

6. The tripod according to claim 2, comprising means for storing electrical energy which are associated with the support elements and which are connected to the circuit means.

7. The tripod according to claim 1, wherein a seat which extends longitudinally and which is arranged to receive at least one photovoltaic panel of the photovoltaic means is on the tubular element.

8. The tripod according to claim 1 in which said photovoltaic means include a flexible panel adapted to be laid between two adjacent legs of the tripod and fixed by fixing means to at least one of said support elements.

9. The tripod according to claim 8 in which said flexible panel has a substantially trapezoidal shape.

10. The tripod according to claim 8 in which said flexible panel is fixed or fixable to a container adapted to contain the tripod and the panel.

11. (canceled)

12. The tripod according to claim 2, wherein each of said legs comprises a tubular upper element and wherein the photovoltaic means for converting energy extend over the outer surface of said tubular upper element.

13. The tripod according to claim 3, comprising means for storing electrical energy which are associated with the support elements and which are connected to the circuit means.

14. The tripod according to claim 4, comprising means for storing electrical energy which are associated with the support elements and which are connected to the circuit means.

15. The tripod according to claim 5, comprising means for storing electrical energy which are associated with the support elements and which are connected to the circuit means.

16. The tripod according to claim 7, wherein the at least one photovoltaic panel is formed on the tubular element.

17. The tripod according to claim 7, wherein the at least one photovoltaic panel is fitted onto the tubular element.

18. The tripod according to claim 9 in which said flexible panel is fixed or fixable to a container adapted to contain the tripod and the panel.
